(19) United States
(12) Patent Application Publication
(10) Pub. No.: US 2020/0396195 A1
(43) Pub. Date: Dec. 17, 2020

(54) System And Method Of Operating An Email Service For Mobile Telephones

(71) Applicant: Anil Goel, London (GB)

(72) Inventor: Anil Goel, London (GB)

(21) Appl. No.: 16/955,245

(22) PCT Filed: Dec. 18, 2018
(86) PCT No.: PCT/EP2018/085498

§ 371 Date: Jun. 18, 2020

(30) Foreign Application Priority Data
Dec. 19, 2017 (GB) 1721266.3

(51) Int. Cl. H04L 12/58; H04L 29/12

(52) U.S. Cl. CPC H04L 51/22; H04L 51/38; H04L 61/304; H04L 61/307; H04L 51/28

(57) ABSTRACT

For email communication, an APP downloaded onto a smartphone and email accounts are automatically provided through an associated server system. Each email account is uniquely related the APP and includes a key associated with the telephone number.

### FIELD OF THE INVENTION

The present invention relates to a system with an email service on mobile telephone and a method of operating such system.

### BACKGROUND OF THE INVENTION

Short Messaging Service (SMS) serves its purpose on mobile telephones, also called cell phones, for simple and short written messages over mobile networks. SMS is advantageous to a certain extent in that it can be used on simple types of mobile telephones that do not even have Internet access capabilities. However, if the cell phone is of the advanced type having Internet access and being provided with a mobile operating system that is capable of running downloaded applications, it will typically run over-the-top (OTT) instant message applications and services over the Internet. Examples are WhatsApp™ or WeChat™, by which messages are sent using data connections, for example WiFi connections, without inducing the relatively high communication charges for SMS. Also, it is possible to send pictures, videos, and voice messages through these applications and services, which has a high popularity, especially among young people.

Email has been a major useful communication tool for a very long time. According to current reports, there exist 5 Billion email accounts used by 2.5 Billion users. Despite wide popularity, setting up an email account is not an easy task for many people, be it as a basic email account accessible from a desktop computer, laptop computer, or from a mobile telephone. Due to these setup difficulties with email accounts, many users prefer using instant message applications and services, which hardly requires any setup as their primary communication tool.

This is in line with the fact that, in emerging mobile-first markets for example Africa, India, Latin America, Middle East, South East Asia, it is generally more customary to use a mobile telephone for communication rather than a desktop or laptop computer. In many cases, the person does not have access to such computer, or even knows how to send an email. For example, in a recent study in India, 90% of computer users did not know how to send an email. However, although, the instant message applications and services fulfil the need of a primary communication tool between one person to another person, these message applications and services do not entirely substitute the need and advantages of email services, which is typically a primary communication tool between the government and a person or a private company and a person, for example customer services. Nowadays, an email is needed for a large number of online transactions, including shopping, travel booking, and banking. In addition to this, it is important to point out that, in some instances, email service is the only communication tool available. An example is letter service from the government authorities. Accordingly, it is desirable to provide an easy way to obtain and operate an email account for mobile telephones.

However, ease of access to obtain an email service does not account for all shortcomings with respect to email. For example, due to the large number of different email accounts, it is very difficult to get email accounts with personal names that are easy to remember. Often, the name has to be combined with numbers, as generally the same name has already been taken by another email user. This results in email addresses that contain unrelated letters or numbers which are difficult to remember. Even more complicating the email system is the fact that different email providers use different domain extensions or top-level domain (TLD), for example @yahoo.com, @yahoo.in, @yahoo.co.uk, @yahoo.jp @hotmail.com, @hotmail.fr, @hotmail.ru, which makes it even more difficult to remember the email addresses.

For China, a special problem is important to notice. Typically, in China, people have two email accounts, of which one is with Chinese characters and used among Chinese people and if which a different one is with the English alphabet for foreign connections. Most Chinese do not learn the English alphabet until at a later age and are often uncomfortable with its use. However, Western-Arabic numerals have been widely adopted in China as a universal standard that is independent of language, and Chinese people learn it from an early age. Such Western-Arabic numbers, which are now universal, are much easier for Chinese Internet users to understand than the English alphabet, which is studied as a foreign language. Accordingly, an email address with numbers is more universal for Chinese people.

Some mobile network operators provide email forwarding service to forward an email to mobile telephone as SMS messages via an SMS gateway. To determine the SMS gateway domain of the mobile network operator may require research by the user, as typical mobile telephone users, typically, do not know this information when the mobile network operator provides the telephone number. Furthermore, due to number portability, a number is at risk not any longer being associated with the mobile network operator that originally issued it, which implies problems with such network operator-limited systems.

An example of such service provision is by the network operator AT&T®, in which an email address needs a format of the type mobilenumber@txt.att.net in order to be forwarded to the mobile number as SMS message. Through this format, it works only for mobile telephones using AT&T®, specifically, as service provider. However, this email forwarding service is an add-on feature of SMS and is not an email service and also not part of an email account. Thus, despite the advantage of using the mobile number as part of email address for SMS gateway for forwarding emails as SMS, this system has some severe shortcomings.

PCT application WO 2014/102762 A1 by Itia Igal discloses an email system and method as follows:
1) The user approaches the website address ECELL.COM to open an email account.
2) The user enters his mobile number with country code.
3) The ECELL checks whether the mobile number has already an existing email account. In the affirmative, the system declines to open a new account.
4) In case that no account exists, ECELL sends an SMS with an authentication code to verify the mobile number.
5) The user with the telephone having the mobile number enters the authentication code on the website.
6) The user chooses the password.
7) The account creation process in complete and the email account is created as mobilenumber@ECELL.com.
8) If an email is received on the account, the user is informed via a SMS/MMS with informative information e.g. sender and subject.
9) If user wants to receive the whole message on the phone, user needs to configure the ECELL email account on the email client on the phone.
10) The user can configure the ECELL email account on any third party email client (not part of the ECELL system) either on numbers of phones or desktop computers. Thus an ECELL email account can be linked/operated with number of email clients or vice versa at the same time.

The US patent application no. 2010/0178944 A1 by Nicolas Philippe Fodor discloses an email system of automatic email creation as follows:
1) A sender sends an email from the any device capable of sending email, for example a desktop or mobile telephone, to an email address defined as mobilenumber@Freedomail.com
2) The FREEDOMAIL server checks whether the email account exist and creates an account if it does not exist.
3) The system sends an SMS/MMS to the mobile number to inform that an email has been received for the user with a selectable link to access the message.
4) On selection, the user is provided with access on a webmail.

Although no detail description is provided, by inference it seems that the first time the user selects the link, it will bring the user to a webmail to choose the necessary password and other details in order to activate and operate the FREEDOMAIL email account. Once the password has been chosen, the user can configure the FREEDOMAIL email account on an email client (not part of the FREEDOMMAIL system) on any number of phones or desktop computers. Thus a FREEDOMAIL email account can be linked/operated with number of email clients or vice versa at the same time.

Both of the ECELL and FREEDOMAIL systems have a fundamental drawback in that it assumes that the user/owner of a mobile number will not change after the email account has been activated. So when the network operator recycles the mobile number, the new user/owner will not be able to open an email account if the previous user/owner had already opened an email account with the system.

There is another drawback in FREEDOMAIL system, the user cannot setup an own email account unless the user sends an email to herself/himself from another email, which the user may not have in the first place.

In essence, the above prior art are conventional email system developed and designed for desktop computer with an additional feature that the email address contains the mobile number.

GB2547231 discloses a multi-factor authentication (MFA) systems which upon receiving a user ID (e.g. email address) from an enterprise authentication system, transmits a registration token to a user. The user returns the token over the cellular packet network where a Mobile Station International Subscriber Directory Number (MSISDN) (i.e. a phone number) is added to the header. The username (i.e. email address) and password combination represent a pair of credentials that the user knows and so this is representative of a single authentication factor. To further improve the security of the enterprise service, a two- or multi-factor authentication system is put in place to further authenticate the user. Reference is made to “something physical that is registered to the user”, for example the mobile telephone.

EP3065435 discloses use of an MSISDN as digital identity in addition to an authentication step where the user has to enter a PIN code.

These conventional email systems require a password, which many people have a tendency to forget due to stringent password creation rules for example at least 8 characters long, at least one capital letter, at least one digit and at least one special character. Although, devices can be configured to automatically store and use the password, the problem persists when the user is changing the device, as the new device needs at least a one-time input of the password. If a password is forgotten, the recovery process is cumbersome and may imply the necessity of a further email account, which the user may not have. As a result, many people lose their email account, and the only option for these people is to set up a new email account with new email address and not only go through the great inconvenience of communicating the new email address to all their contacts but may also lose some important emails which are impossible to recover. Accordingly, an email account without a password would be advantageous for many people especially occasional users and old people.

Additionally, these existing systems require technical knowledge to configure an email account on an email client on a mobile telephone for the user to operate the email account on the mobile telephone after the email account has been created/setup on the webmail. There are many common problems in configuring an email account on an email client for example: a) I can't send or receive, b) I can receive but I can't send, c) I can send but I can't receive etc. Troubleshooting these problems is not easy and needs technical knowledge and understanding of parameters/specifications such as incoming mail server, outgoing mail server, type of account POP or IMAP, SSL and non SSL, port numbers. Accordingly, an email account without the need for configuration would be advantageous for many people who are not tech savvy or do not have a technical background.

Some other prior art systems suffer similar disadvantages with respect to user friendliness. For example, EP2961208 discloses a procedure for accessing a mobile payment service. For such service, a token is received by the mobile phone after request thereof, for example into a mobile wallet application.

EP2652097 discloses an access to a service, primarily a WLAN access, with a time limitation. An address identifier MSISDN is used to identity the mobile telephone accessing the service, but the MSISDN is not an address of the service itself. Accordingly, there is a need for improvements in relation to email accounts and email system.

### DESCRIPTION/SUMMARY OF THE INVENTION

It is therefore the objective of the invention to provide an improvement in the art. In particular, it is an objective to develop and design an email system for mobile telephones. Especially, it is an objective to provide a simple way to obtain and configure an email account on a mobile telephone and which is easy to remember. It is a further objective to provide an email system which is more universal than existing systems.

These and more objectives are achieved with an email system and method as explained in the following.

In summary, in order to achieve at least one of these objectives for email communication, an APP is downloaded onto a Smartphone, and an email account is automatically provided through an associated application server system. Each email account is uniquely related to the APP and includes a key associated with the telephone number. Further details are explained below.

The term “Smartphone” is used herein as a mobile telephone with capabilities for Internet access and with an advanced mobile operating systems that is capable of running downloaded computer applications, commonly called APPs. Examples of such advanced operating systems are iOS® for iPhone® provided by Apple®, or Android™ or Microsoft Windows®. This list is not exhaustive.

A number of terms are used as follows:

The term “conventional email address” is used for email address without containing a mobile telephone number of the user.
The term “conventional email account” is used for email account with conventional email address.
The term “proprietary email address” is used for email address containing a mobile telephone number of the user.
The term “proprietary email account” is used for email account with proprietary email address.
The abbreviation SMTP is used for Simple Mail Transfer Protocol.
The term “SMTP format” is used for the coding format of an email for SMTP.
The term “conventional email” is used for email in SMTP format.
The term “proprietary communication protocol” is used for an email sending protocol that is different from SMTP and used for communication between the APP and the application server system; this protocol is used in certain embodiments in order to prevent communication with the APP by SMTP.

The term “proprietary communication protocol format” is a coding format of an email sent by the proprietary communication protocol.

The term “proprietary email” is used for an email containing the telephone number as part of the email address. Optionally, the proprietary email and the corresponding communication is provided in in the proprietary communication protocol format.

The term SMS is used for Short Message Service.
The term “activating an email account” is used for creation of an email account and setup thereof with an email address identifier.

A system is provided for activating an email account and sending and receiving emails on a mobile telephone. The system comprises a first mobile telephone that contains a SIM card with a registered first telephone number, TelNo1, and with Internet access capabilities. A first email software application, APP1, is installed on the first mobile telephone, wherein APP1 is non-transferable to other mobile telephones after installation. Optionally, it is non-reinstallable on the first mobile telephone. The APP1 is configured for automatically providing a first software key and second software key, and sending a key-combination of the first and the second software key to an application server system associated with APP1. The application server system that is associated with APP1, is configured for receiving the key-combination from APP1 as an authorization code for email transactions. The first email account is uniquely associated to the key-combination.

The application server system is further configured for email transactions for receiving emails by the application server system from APP1 and sending the received email to a recipient address and receiving emails addressed to the first email account from other email addresses and sending those emails to APP1 for display to the corresponding user of the first mobile telephone. For example, for receiving as well as drafting and sending emails by the user, the APP1 has in-built email client with a user interface.

As already mentioned above, in prior art email systems, two software keys are used for access to an email account, namely a username and a password. The username is an identification code, ID, of the email address and is fixed once for all and cannot be changed for an email account. The password is determined by the user and can be changed upon user request.

In contrast to the prior art system, the invention uses a different combination of two software keys for access to an email account. The first key is an identification code, ID, of the email address and can be assigned to a different, new email account, which then typically belongs to a different user. This feature is different from the prior art. The additional second key is fixed to the APP that is used for the email service. Advantages in comparison with the prior art will be discussed in the following with a more detailed explanation of the functions of the two keys.

In practical embodiments, the first key, TelNo1Key, is uniquely linked to the first telephone number, TelNo1. For example, the first key is the TelNo1 or contains the TelNo1 as part of an alphanumeric sequence. Alternatively, TelNo1Key is a code derived from TelNo1, for example an encrypted code uniquely linked to the first telephone number, TelNo1. The term “uniquely linked” means that there is only one first key, TelNo1Key, for the TelNo1 and vice versa.

The second software key, APP1Key, is uniquely linked to APP1. This implies that each installed software application APP on a telephone is linked to the mobile telephone. Correspondingly, the first software application, APP1, when installed on the first mobile telephone is non-transferable to other mobile telephones and, optionally, also non-reinstallable on the first mobile telephone.

This implies that a user with a specific mobile telephone onto which the APP1 is installed carries one of the keys by the mobile telephone, namely the APP. The email account cannot be accessed without the mobile telephone on which the APP1 is installed. Secondly, the user carries also the second key, namely the SIM card with the specific telephone number of the mobile telephone.

The application server system is configured for email transactions for the first email account only upon receipt of the key-combination, Comb(TelNo1 Key, APP1Key), from the APP1.

For example, the application server system is configured for email transactions for the first email account only if the first telephone comprises the SIM card with the registered first telephone number. Consequently, removal of the SIM card from the mobile telephone would stop access to the email account.

In comparison to the prior art, where username and password are independent of device, the invention provides an email system that is linked to hardware, namely the mobile telephone onto which an APP1 has been installed, and optionally also the SIM card in the mobile telephone. The APP1 itself is linked to the telephone, as long as the APP1 is installed and not deleted from the telephone, and the APP1 uses the telephone number from the SIM card for obtaining access to the email account. For the user, this implies advantages of high security while at the same time a high degree of automation without a necessity of creating and remembering passwords.

In some simple embodiments, the TelNo1Key is identical to TelNo1 or comprises TelNo1 as part of an alphanumeric sequence. Optionally APP1 is an alphanumeric ID number of the APP1. As an example, the key-combination, Comb(TelNo1Key, APP1Key), is an alphanumeric sequence containing TelNo1Key and APP1Key. Alternatively, the key-combination, Comb(TelNo1Key, APP1Key), is encrypted in order not to be deciphered by third parties. For example, the key-combination, Comb(TelNo1Key, APP1Key), is an alphanumeric value derived by a function: Function(TelNo1Key, APP1Key) that has TelNo1Key and APP1Key as variables.

For setting up an email account, the application server system is configured for automatically creating/activating the first email account as a consequence of a first-time receipt of the key-combination by the application server system. Once, the user has installed the APP1, the APP1 collects the TelNo1 from the SIM card of the first mobile telephone and forms the key-combination and submits it to the application server system, either automatically or upon user request, where the first email account is activated.

The system and method as presented herein are integrated end-to-end solution wherein the multiple steps for activating and operating an email on a mobile telephone are reduced to one simple single step, which is in contrast to prior art systems, where multiple steps are needed on separate systems. The system and method eliminates the need for creating a password to activate an email account on the webmail first and then configuring the email account on an email client after the email account has been activated. No password has to be created and memorised or written down. Access is from a single device, namely the mobile telephone. This is a great advantageous for many people who tend to forget a password, especially old people, and for many other people who do have any technical background or know how to configure an email account on an email client.

As it was mentioned initially, the first key is an identification code, ID, of the email address. For example, if the TelNo1Key is an alphanumeric sequence containing TelNo1 or is identical to TelNo1. Thus, TelNo1Key is indirectly linked to the SIM card. The other key APP1Key, optionally, contains the ID of APP1. Optionally, APP1 cannot be transferred to other devices or reinstalled. Thus, APP is indirectly linked to the mobile telephone.

In some embodiments, the application server system is configured for automatically activating a second email account as a consequence of receiving from APP1 a key-combination, Comb(TelNo2Key, APP1Key), wherein TelNo2Key is a software key uniquely associated with a second telephone number TelNo2 of a different, second SIM card in the first mobile telephone.

For example, when the first SIM card with TelNo1 is removed from the first mobile telephone and a second SIM card with a second, different telephone number, TelNo2, is installed in the first mobile telephone, the APP1 automatically provides a different first software key, TelNo2Key, and sends the resulting software key-combination, Comb(TelNo2Key, APP1Key), to the application server system. As a consequence of receiving the new software key-combination, a second email account is automatically created/activated by the application server system, wherein the second email account is uniquely associated to the different key-combination Comb (TelNo2Key, APP1Key).

In some events, the user may swap between different SIM cards in the first mobile telephone, either by installing different SIM cards, or by selecting one of two SIM cards in a dual-SIM telephone. In this case, the user can select between the two created email accounts.

In some embodiment, the application server system is configured for email transactions for the first email account only if the first telephone comprises the SIM card with the registered first telephone number. Consequently, removal of the SIM card from the mobile telephone would stop access to the email account.

Alternatively, by requesting an email-linkage-code when having one SIM card activated and returning the account-linkage-code to the application server system when the other SIM card is activated, the user is capable of linking the two email accounts for Comb(TelNo1Key, APP1Key) and Comb(TelNo2Key, APP1Key) together such that emails from both email accounts are accessible to the user when using either of the two SIM cards. This process can be repeated for multiple SIM cards and corresponding multiple telephone numbers.

In some embodiments, when sending emails by APP1, the sender's proprietary email address of the first email account would depend on the SIM card currently in use. In other words, the SIM card for the first proprietary email address has to be installed in the phone with the APP1 in order for the email account to work.

In some alternative embodiments, the application server system is configured for email transactions for the first email account only if the first SIM card has not been installed in another mobile telephone phone with a different APP. The latter implies that the first email account continues working through the first telephone until the SIM card is changed to another telephone with an APP2. Thus, the SIM card can be removed from the first telephone, and the first email account will continue functioning, until the SIM card is installed in another telephone and a corresponding second email account is activated.

It is emphasized that one APP can be linked to multiple email accounts but one email account can only be linked to one APP at any given time.

In some embodiments, the user may request a number-change-code from the application server system for change of telephone number from the first telephone number TelNo1 to a different telephone number. This is done by the user's input on a user interface of APP1 on the first mobile telephone. By the APP1, the number-change-code is received and displayed to the user. The user would typically record such code or memorise it. Then, the SIM card can be removed from the first mobile telephone and a different SIM card installed in the first mobile telephone with a different telephone number, TelNo2. The APP1 automatically provides a different first software key, TelNo2Key, and sends the resulting software key-combination, Comb(TelNo2Key, APP1Key), to the application server system. As a consequence of receiving the new software key-combination, a second proprietary email account is automatically activated by the application server system. By inserting the number-change-code received earlier on a user interface of APP1 on the first mobile telephone and sending the number-change-code by APP1 to the application server system, access is granted to emails in the first email account despite the change of software key-combination from Comb(TelNo1Key, APP1Key) to Comb(TelNo2Key, APP1Key). For example, the application server system is linking the first proprietary email account to the second proprietary email account, providing access to emails in the first proprietary email account through the second proprietary email account.

In some events, the user with a second SIM card and corresponding second mobile number TelNo2 may not be able to request a the number-change-code when changing the number of the first mobile telephone, for example because a number has been cancelled. In some embodiments, the application server system is providing access by APP1 on the first mobile telephone to previous emails from the first email account, for example by linking the first to the second email account, if after a comparison check there is at least 50%, for example at least 60, 70, 80, or even 90%, identity between the contact lists in the first mobile telephone before and after change of the respective telephone numbers from TelNo1 to TelNo2. This implies that the application server system takes copies of the contact list on the first mobile telephone regularly and stores these in association with the first proprietary email account. Optionally, this feature is implemented as an automatic feature authorised by the user or upon user command and request.

In the case after change of email account, the server stores the copies of the contact list on the first mobile telephone in association with the second proprietary email account.

For example, a second email account is activated for Comb(TelNo2Key, APP1Key), but access is given to the emails of the previous email account associated with Comb(TelNo1Key, APP1Key) by transferring the first email account associated to TelNo1 to the second email account associated with TelNo2 and providing access to previous emails in the first email account through operation of the second email account.

Optionally, the application server system is configured for automatically activating a further email account as a consequence of receiving from APP2 the key-combination Comb(TelNo1Key, APP2Key), wherein APP2Key is a software key uniquely associated with APP2 on the first mobile telephone or on a different telephone containing the first SIM card with the first mobile telephone number TelNo1. The further email account is uniquely related to the new software key-combination Comb(TelNo1Key, APP2Key).

It is common practice to exchange the telephone to a newer model, while keeping the first SIM but having to install a new application of similar type, namely APP2 on the new telephone. For example, by removing the SIM card from the first mobile telephone and installing the SIM card in a second mobile telephone and providing the second mobile telephone with a second email software application, APP2, similar to APP1 but with a different software key, APP2Key, APP2 would be sending a new software key-combination Comb(TelNo1Key, APP2Key) to the application server system. This triggers the activation of a different email account. This is done to safeguard the interest of the users, had the telephone number was acquired by the second user.

In order for the first user to keep the emails from the previous first email account, despite having initiated the activation of a further email account related to the new software key-combination Comb(TelNo1Key, APP2Key), the first user may request on the user interface of APP1 on the first mobile telephone by user command an APP-change-code from the application server system for change of the APP. The APP1 would then receive the APP-change-code and display it to the user for recording. The SIM card can then be removed from the first mobile telephone and installed the SIM card in a second mobile telephone, which is then provided with a second email software application, APP2, similar to APP1 but with a different software key, APP2Key. Accordingly, APP2 sends a software key-combination Comb(TelNo1Key, APP2Key) to the application server system, which optionally activates a new email account due to the new software key-combination Comb(TelNo1Key, APP2Key). However, by inserting the APP-change-code on a user interface of APP2 on the second mobile telephone and sending the APP-change-code by APP2 to the application server system, the application server system is providing access to the emails in the first email account despite the changed software key-combination from Comb(TelNo1Key, APP1Key) to Comb(TelNo1Key, APP2Key).

In some events, the user with a new phone and corresponding new APP2 may not be able to request a APP-change-code, for example if the first mobile telephone is lost or stopped functioning. In some embodiments, the application server system is providing access to previous emails from the first email account by APP2 on the new telephone, if after a comparison check there is at least 50%, for example at least 60, 70, 80, or even 90%, identity between the contact lists in the first and second telephone. This implies that the application server system takes copies of the contact list on the first mobile phone regularly and stores it in association with the first email account. Optionally, this feature is implemented as an automatic feature or upon user command and request.

For example, the application server system is linking the first email account associated to APP1 to the second email account associated with APP2 and providing access to previous emails in the first email account through operation of the second email account.

In case that the user has deleted or lost the contact list, or the user cannot restore the contact list on the new mobile telephone and is neither in the position to receive a number-change-code or APP-change-code, a contact list comparison check procedure is not possible for access to the emails of the first email account.

In order to overcome such difficulty and make changes of telephone numbers and/or mobile telephones possible without losing the first email account, an optional solution is found in the following. In this case, the first email account is made accessible to the user despite change of telephone number and/or APP, if the user sends the mobile phone bills before and after the change as a proof to the customer services, for example via email through the APP. For customers using prepaid airtime, the customer service would request proof that the SIM with the first telephone number is registered in the same name before and after the change. On successful verification by the customer services the first email account is linked to the new email account.

As already mentioned earlier, a simple email address is derived from the mobile number of a mobile telephone by including the telephone number in the email address, either by the email address identifier being identical to the mobile number, which makes it simple for other users to send an email, or by including the mobile number in an alphanumeric sequence.

In practical embodiments, the email address contains the first telephone number TelNo1 together with a specific domain name associated with the application server system and a top-level domain. An example of an email address for the first mobile telephone with APP1 is TelNo1@DomainName.TLD, where TLD is an abbreviation for Top Level Domain.

Optionally, the first mobile number TelNo1 contains the country code as part of the email address. Well knowing that mobile telephone numbers when including the country code are unique, the system can be designed to work worldwide. In such case, the system is configured for sending emails from the APP1 of the first mobile telephone to a corresponding APP2 on a second mobile telephone across country borders.

For various mobile telephones, a generalized format can be expressed as “TelNo@domainname.TLD” which is potentially used as email address. Thus, the email address contains the mobile number, which for international use also contains the country code. It also contains a domain name, “domainname”, as part of the email address, for example with the format “@domainname.com”, where “com” is a specific example of top-level domain (TLD). Other examples of TLD are “eu” or “in”. Optionally, a single domain name is used for an entire country or even for a plurality of countries, thus, extending the system internationally with service across country borders.

Optionally, the system spans over various, or even all, accessible mobile network operators throughout the world. In this case, the system can be used for any mobile telephone number, be it nationally or internationally, independent of mobile networks operators, for example Orange®, Vodafone®, or AT&T®. For example, the system uses a domain name on the Internet for all mobile numbers irrespective of which mobile network operator has issued the mobile number and which mobile network operator provides telephone network service and Internet access. For these embodiments, the application server system is configured for sending emails from APP1 of the first mobile telephone to an APP2 on a second telephone, despite the first and second mobile telephone being serviced by different mobile network operators.

Optionally, the system also supports alternative domains, such that an alternative domain is an alias to the original domain. For example, the following two email addresses TelNo@people.com and TelNo@55.com could potentially denote the same delivery address, where “people.com” is a specific example of an original domain and “55.com” is a specific example of an alternative domain. Such principle of dual domain links can be useful for people who do not understand the English Alphabet, and may also prevent users from the necessity of shifting between different keyboards.

In some embodiments, the APP and the application server system are configured for sending emails between the APP and the application server system only according to a proprietary communication protocol, which is different from SMTP.

Typically, the application server system comprises numerous servers that are used in combination. For example, the numerous servers include proprietary email servers as well as conventional email servers. In this case, the proprietary email servers are specifically associated with the APP and use only the proprietary communication protocol for emails communication with the APP. The purpose is that only the proprietary email servers are able to communicate directly with the APP. The conventional email servers use SMTP in the Internet and are used for sending and receiving conventional emails from computers or mobile telephones. Accordingly also, only proprietary email servers are used for sending and receiving emails from a first email address of the format TelNo1@domainname.TLD to a second email address of the format TelNo2@domainname.TLD.

For example, the installation procedure for the APP includes downloading the APP over the Internet onto the mobile telephone and installing the APP thereon. For sake of universality, similar APPs may be provided for various mobile operating systems, for example iOS®, Android™ and Windows®, the list not being exhaustive. Advantageously, the installation procedure of the APP also includes automatically receiving the telephone number of the SIM card by the APP and sending the telephone number to the application server system. Alternatively, the APP prompts the user to type in the mobile telephone number on the keypad of the mobile telephone.

Once, the proprietary email account is activated on APP1, it presents an email client to the user of the first mobile telephone and prompts the user to type a telephone number as email recipient. Alternatively, APP1 prompts the user to select an email recipient among contact numbers stored in a contact list of the first mobile telephone, upon which APP1 extracts the recipient's telephone number from the contact list. On the basis of the recipient's telephone number, TelNoX, the APP1 creates a recipient's proprietary email address, for example in the format of TelNoX@domainname.TLD. The APP1 is further prompting the user to insert an email content, and does upon user command send the email with the recipient's proprietary email address from APP1 to the application server system for forwarding it to the recipient's proprietary email address.

When the application server system receives the email with the recipient's proprietary email address containing TelNoX from APP1 on the first mobile telephone, the application server system checks whether a proprietary email account is activated with such recipient's proprietary email address. In the affirmative, this is equivalent to the recipient having APPX on the corresponding mobile telephone, and the email is forwarded to the APPX on the recipient mobile phone by using the proprietary communication protocol.

However, if such recipient's proprietary email address is not activated, other actions are necessary. For example, a text message, for example in the format of SMS is sent to the recipient's telephone number TelNoX, where the text message contains a prompt to the recipient for downloading the APP on the recipient's telephone in order to receive the email. This facilitates the distribution of the APP among a large user group and makes the sending of emails for the first user very easy. For example, the user receives a message, “Hi there, I am using a new email system with email address based on your mobile number TelNoX, please, download the corresponding APP for ease of communication”.

In some embodiments, the system is not limited to sending and receiving email from proprietary email accounts, where the mobile telephone number is part of the email address. Instead, the system is also configured to send and receive emails to and from conventional email addresses that are not based on the mobile telephone number.

For example, the application server system is configured for receiving an email from APP1 on the first mobile telephone, the email comprising a recipient's conventional email, wherein the application server system is configured for sending the email according to SMTP to the recipient's conventional email address. Alternatively, or in addition, the application server system is configured for receiving a conventional email according to SMTP from a sender's conventional email address, the conventional email comprising a recipient's proprietary email address, the application server system further being configured for sending the email to APP1 on the first mobile telephone.

In the case of the communication between the APP and the application server system is only according to a proprietary communication protocol the two above examples turn into the following configuration. In this case, the application server system is optionally configured for receiving a proprietary email from APP1 of the first mobile telephone according to the proprietary communication protocol, the email comprising a recipient's conventional email address, and the application server system is configured for converting the proprietary email to a conventional email and sending the conventional email according to SMTP to the recipient's conventional email address. Alternatively, or in addition, the application server system is configured for receiving a conventional email according to SMTP from a sender's conventional email, the conventional email comprising a recipient's proprietary email address, and the application server system is further configured for converting the conventional email to a proprietary email and sending the email to APP1 on the first mobile telephone by using the proprietary communication protocol.

This gives the user the option of composing an email by either selecting a contact stored in a contact list of the mobile telephone as email recipient, type in a telephone number, type a conventional email address, or select a conventional email stored in the contact list of the mobile telephone.

In some embodiments, the APP receives multiple telephone numbers from the contact list on the mobile telephone and submits the telephone numbers to the application server system. The application server system would then check whether for some of the received telephone numbers of the contact list no corresponding proprietary email accounts activated, select those telephone numbers and automatically send an SMS to those telephone numbers, the SMS prompting download of the APP. In this case, all or some contacts from the contact list in the mobile telephone are automatically prompted to download the APP. Such viral prompting would quickly result in a large number of people to have the APP installed in an easy way. However, in order to prevent uncontrolled distribution of the APP, the submission of the telephone numbers of the contact list to the application server system by the APP is, optionally, initiated only upon confirmation by the user after being presented by a prompt from the APP for the submission of the telephone numbers.

Optionally, the proprietary communication protocol is different from Simple Mail Transfer Protocol (SMTP), so that communication to and from the APP is only through the associated proprietary email servers, which gives a high degree of control and security. For example, the number of email spam and virus distribution can be efficiently reduced. Optionally, the proprietary communication protocol, includes automatic prompting the user of APP1 on the first mobile telephone as to whether or not to accept receipt of an email from an email sender, for example an email sender address whom which no email has been received earlier. In the event of non-acceptance by the user, the system denies receipt of the email by APP1 and prevents downloading the email to APP1 on the first mobile telephone from the application server system. Optionally, the email is sent back to the sender in such event, notifying the sender that the recipient does not wish to accept the email from the sender. In this case, emails are only received upon acceptance of the sender. Thus, spam and malware risks are reduced in that they do not find way to the email account without explicit permission.

This is very different from SMTP, in which the recipient has to set up rules for those senders from which the emails are not desired. The conventional email system with SMTP implies that spam and emails with viruses are received from any corresponding new email sender. Although, conventional email servers have built-in some filtering mechanisms for spam and viruses, these are easy to avoid by intelligent programming from active spam and virus distributors. On the other hand, such conventional filtering mechanisms, which are meant to filter spam and viruses, also involve a risk for errors in the automatic rejection, such that some of the emails that are important to the recipient are also rejected.

For the proprietary communication protocol, where the proprietary email server is prompting the user to accept a new sender, such automatic but unintended rejection of emails is also eliminated, improving further user friendliness and versatility of the system.

Additionally, as an option, the proprietary email server can be configured to block selected email addresses. In such an event, the future emails from such blocked email address will be returned back to the sender and not sent to the App. The returned email will notify the sender that the recipient has blocked the sender.

Optionally, in some embodiment, the emails to the first proprietary email account are forwarded to a second proprietary email account until the new owner/user of the first mobile telephone number activates the new proprietary email account on the new APP on the new mobile telephone. This will help facilitate the smooth transition from first proprietary email account to second proprietary email account.

The functions as described above are achieved by proper programming of the application server system and the APP. In particular,
the APP is programmed, as part of the installation procedure of the APP, for receiving the telephone number of the SIM card by the APP and sending the telephone number and the second software key, related to the ID of the APP, to the application server system associated with the APP to activate an email account, for example a proprietary email account, by the application server system;
the APP is programmed, after receipt of confirmation of activation of the email account, for example proprietary email account, for presenting an email client to the user of the telephone and prompting the user to select a recipient among contacts stored in a contact list of the phone as email receiver, and further programmed for extracting the recipient's telephone number from the contact list;
the APP is programmed for prompting the user to insert an email content, the email content comprising at least one of a text, a voice message, a document, a photo; a video or music;
the App is programmed for submitting the email with the recipient's telephone number to the application server system for further submission to the corresponding App on the recipient's mobile telephone.

In order to facilitate keeping an overview of emails and their attachments, the system and method comprises keeping the link to the email with the attachment. Thus, the user can at all times find back to the original email with the specific attachment either from the APP repository or from the mobile telephone various folders. For example, the link is effectuated by a simple pointer action from the user, in which case the user interface switches from presenting the attachment to presenting the email that originally contained the attachment.

Optionally, the system and method comprises automatically appending the sender's name and the date received to the attachment name. As a further optional feature, the system and method may be configured for automatically indicating the number of times the attachment has been viewed/open by the user.

The email signatures and disclaimers could be very distracting and inefficient while viewing the email thread, especially, if the signature and disclaimers contains logos, large images and long text. Advantageously, the system and method comprises automatically hiding the signatures and disclaimers in the email thread except from the original email from the sender for easier and efficient review of the main content of the email thread.

Optionally, the system and method comprises automatically clubbing all the emails to and from a person similar to email threads including multiple accounts corresponding to different mobile telephone numbers and/or conventional email accounts maintained for easier and efficient review of all of the communication to and from the sender in one continuous flow.

In case of an email communication from an organisation, for example a service, the system and method, optionally, comprises automatically clubbing together all the emails from the different departments, both from external and internal domains of the service, in order to unclutter the mailbox for effective and efficient management of the mailbox. For example, in relation to the following addresses,
Support@networksolutions.com,
NetworkSolutions@info1.networksolutions.com,
NetworkSolutionsRenewals@info1.networksolutions.com,
NetworkSolutions@mail1.networksolutions.com,
   it is observed that NetworkSolutions and NetworkSolutionsRenewals are specific examples of different departments; and networksolutions.com is specific example of an external domain, while info1.networksolutions.com and mail1.networksilutions.com are specific example of internal domains.

The system as described above could be advantageously used by organisations for two-factor authentication, transactional information, for example flight confirmation, pin code reset, bank balance alerts, as well as for customer relationship management services and promotional campaigns instead of application-to-person (A2P) SMS.

Optionally, the application server system can also be configured to access the email account via a desktop application or web application. The desktop-access-code or web-access-code for APP1 is sent to the first mobile telephone for input into the desktop keypad in order to access the desktop application or web application. On successful verification, the user will be able to send or receive the email from first email account from desktop application or web application.

### SHORT DESCRIPTION OF THE DRAWINGS

The invention will be explained in more detail with reference to the drawing, where

FIG. 1 is a flow chart illustrating the stages to activate a proprietary email account for the smartphone for sending and receiving emails;

FIG. 2 is a flow chart illustrating the stages for sending and receiving emails between two proprietary email accounts;

FIG. 3 is a flow chart illustrating the stages for sending an email from the first proprietary email account to a conventional email address;

FIG. 4 is a flow chart illustrating the stages for receiving an email from a conventional email address to proprietary email address and forwarding it to a smartphone.

FIG. 5 is a flow chart illustrating the stages for changing the TelNo and transferring the previous proprietary email account to the new proprietary email account

FIG. 6 is a flow chart illustrating the stages for changing the APP and transferring the previous proprietary email account to new proprietary email account

### DETAILED DESCRIPTION/PREFERRED EMBODIMENT

The system is explained in more detail in the following by referring to various examples. The examples are given with respect to a proprietary email account that has the telephone number as part of the proprietary email address.

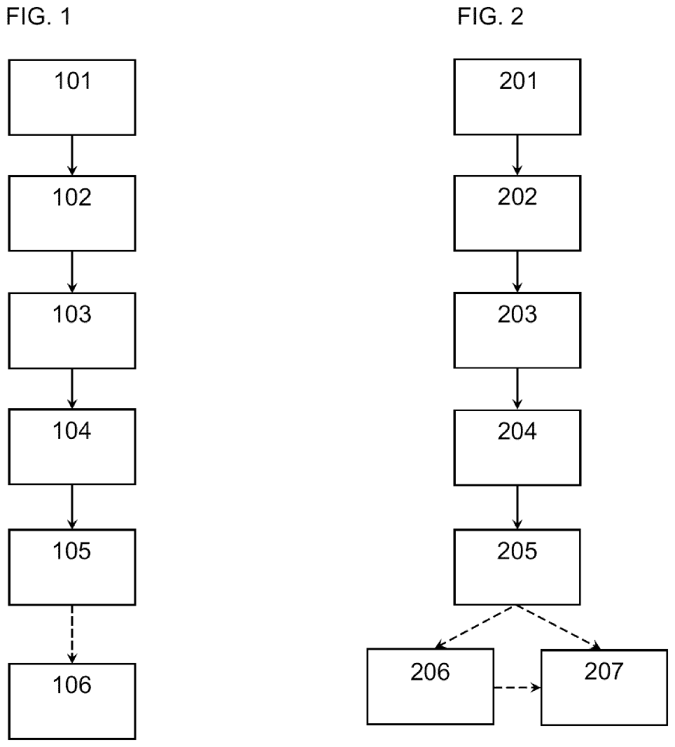

With reference to FIG. 1, the following stages are performed to prepare a mobile telephone for sending and receiving emails.

Stage 101: A first mobile telephone of a first user is provided with a SIM card inside having a first registered telephone number “TelNo1”. A first App “APP1” is downloaded, with an appropriate APP distribution service for example PlayStore™ for Android and AppStore™ for iOS®, through the Internet onto the first mobile telephone and installed thereon.

Stage 102: As part of the installation procedure, APP1 receives “TelNo1” from the SIM card, either automatically or by user input, and submits the key-combination, Comb(TelNo1Key, APP1Key) automatically to the application server system.

In the event the TelNo1 is by user input, the application server system sends a SMS with an authentication code to the telephone number to verify the correctness of telephone number. On receiving the authentication code by user input, the APP submits it automatically to the application server system.

Stage 103: Upon receipt of the key-combination, Comb(TelNo1Key, APP1Key), the application server system automatically activates a first proprietary email account with the first email address “TelNo1@domainname.TLD”. Thus, the email address contains the mobile number, which for international use also contains the country code. It also contains a domain name, “domainname”, as part of the email address, for example with the format “@domainname.com”, where “com”, is a specific examples of top-level domain (TLD).

Stage 104: The application server system confirms to APP1 that a proprietary email account has been activated.

Stage 105: Upon activation of first proprietary email account, either automatically or by user confirmation, APP1 sends a copy of the contact list on the first mobile phone to the application server system to be stored in the first proprietary email account or be stored in association with the first proprietary email account. The APP continually updates the stored contact list on the application server system.

Optional stage 106: Optionally, APP1 prompts the user to indicate whether the established first proprietary email account should be linked to a conventional email address to which all received emails are forwarded. This option gives the user the possibility to use an existing conventional email account, which will also receive all emails that are received by proprietary email account. For others, this implies the advantage that they do not need to remember or store the email address of the conventional email account but only the first telephone number. This is an advantage because contact lists in telephones typically only contain the telephone numbers of contacts, which are stored upon receipt of a call and typically not even inspected and remembered by the user. If the first user indicates that a link to a conventional email account should be established, APP1 submits the information to the application server system which registers such forwarding link in connection with the first proprietary email account.

After these few stages, the user is ready to send and receive emails. It is universal for any telephone number in any country and independent of the specific telephone service provider, for example Orange®, Vodafone®, or AT&T®.

With reference to FIG. 2, an example is given for sending and receiving email between two mobile telephones.

Stage 201: Upon activating the first proprietary email account for the first telephone number, APP1 on the first mobile telephone presents an email client to the first user as a prompt to compose an email by inserting a telephone number “TelNo2” to which an email should be sent. The first user either enters a telephone number on the keypad or selects a certain contact number “TelNo2” from the list of contacts stored in the first mobile telephone. A proprietary email address is automatically created by APP1 of the format “TelNo2@domainname.TLD”

Stage 202: The user finalises the email by inserting text in a subject field and/or the email body, optionally with attachments, such as documents, images, or videos.

Stage 203: Upon user command and request, APP1 sends the email to the application server system, optionally by using a proprietary communication protocol different from SMTP.

Stage 204: The application server system receives the email and checks whether a proprietary email account with “TelNo2” in the address is already activated.

Stage 205: In the affirmative, the application server system stores the email onto that account and establishes a connection to the second APP, APP2, on the second mobile telephone with “TelNo2” and forwards the email to APP2 on the second mobile telephone, optionally by using a proprietary communication protocol.

Optional stage 206: If such proprietary email account does not yet activated, the application server system sends a message, typically via SMS, to the second mobile telephone that an email is pending for receipt and prompts the second user of such second mobile telephone to install the APP on the second mobile telephone. For example, the installation of the APP is done automatically upon confirmation by the recipient, which becomes a second user, optionally by pressing on a link in the SMS message. Optionally, a message is sent to the first user that the recipient does not yet have the APP, which motivates the first user to contact the recipient and ask him/her to install the APP. Once the APP is installed to the second mobile telephone, the email is sent to the second APP on the second mobile telephone. The received email is pushed to the second APP on the second mobile telephone automatically, optionally by the proprietary communication protocol. Alternatively, the forwarding is done by a pull-action, in which the forwarding is paused until ordered by the second APP of the second mobile telephone, for example upon activation of the second APP by the second user.

Optional stage 207: Optionally, the application server system confirms to the first user the proper delivery of the email to the second mobile telephone.

For example, the proprietary communication protocol contains certain proprietary functions. One of the optional functions is a prompt for confirmation whether an email sender address is accepted for the current and/or future emails. Such function largely eliminates receipt of spam mails. The prompt for allowing email delivery from specific senders is optionally a selected function; for example, the first user may select receiving all emails from contact persons according to the contact list but request a prompt for other senders. Alternatively, the user may request a prompt for each email sender from which an email has not been accepted for delivery before. Blocking senders is also an option to avoid spam.

In order to facilitate message transfer, the APP is optionally configured to allow sending the same email to numerous recipients selected among contacts in the contact list or even to all contacts in the contact list and, potentially to further added contacts which are not in the list. Those contacts that already have such APP installed will receive the email and those contacts that have not yet installed the APP will receive a message, typically SMS message, motivating the recipient to install the APP. This is also a way to distribute the APP quickly to a large number of users.

The APP is optionally configured for storing email history per sender/recipient, similarly to what users today are used to in messaging application and services, such as WhatsApp®, WeChat®, Viber®, or Instagram®. This makes it easy for the user to trace email conversations.

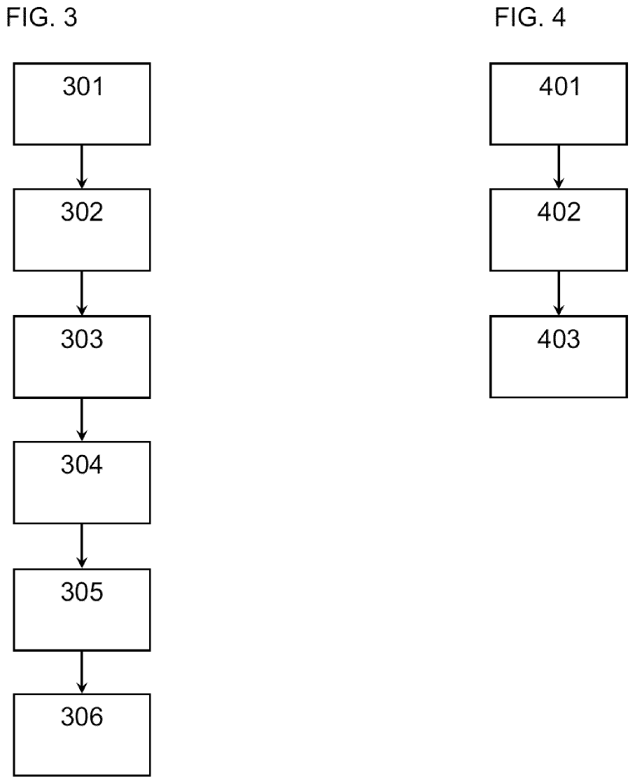

With reference to FIG. 3, the following stages are performed in order to send an email from the first application, APP1, on the first mobile telephone to a conventional email address.

Stage 301: The user composes an email by inserting a conventional email address as an alternative to a telephone number to which an email should be sent. The first user either types in a conventional email address or selects a certain email address from a stored list in the first mobile telephone.

Stage 302: An email is generated by the user by inserting text in a subject field and/or the email body, optionally with attachments, such as documents, images, or videos.

Stage 303: Upon user command and request, APP1 sends the email to the application server system, optionally according to the proprietary communication protocol.

Stage 304: From APP1, the application server system receives the proprietary email, optionally according to the proprietary communication protocol, where the email contains a conventional email address to which the email should be sent.

Stage 305: For the case that the proprietary email is provided in a proprietary format, the application server system converts the proprietary email from a proprietary communication format to a conventional email in SMTP format and sends the email according to the SMTP via the Internet to the conventional email server system that is associated with this conventional email address. For example, the conventional email server system is an MTA (mail transport agent) server system, optionally using Microsoft Exchange®, qmail™, Exim™ or sendmail™ as an email routing program.

Stage 306: The corresponding conventional email server system receives the email from the Internet.

With reference to FIG. 4, the following stages are performed in order to receive an email from conventional email address and forward it to APP1 on the first telephone in a proprietary format.

Stage 401: The application server system receives a conventional email for the address “TelNo1@domainname.TLD” through the Internet from a conventional email server system, according to SMTP.

Stage 402: The application server system converts the conventional email from SMT format to a proprietary email in a proprietary communication format and stores the email in the corresponding proprietary email account of “TelNo1”.

Stage 403: The application server system sends the email to APP1 on the first mobile telephone by proprietary communication protocol.

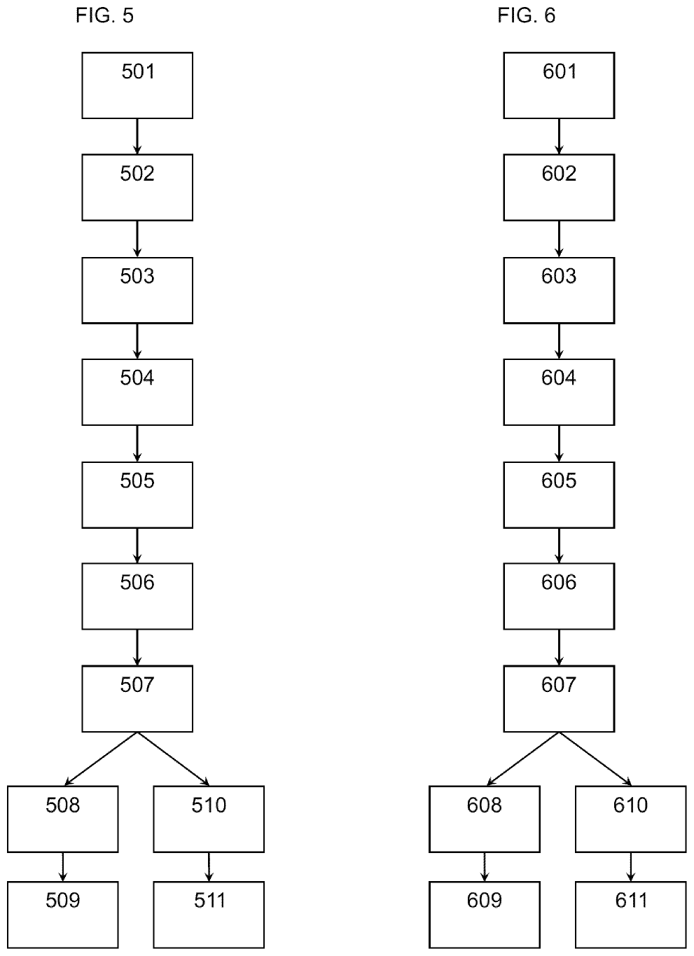

With reference to FIG. 5, the following stages are performed in order to change the TelNo and linking the first proprietary email account to the new proprietary email account.

Stage 501: Upon user command and request, APP1 sends a number-change-code for first proprietary email account to the application server system.

Stage 502: The application server system receives the request and sends an alphanumeric “number-change-code” for first proprietary email account to APP1. The user notes this code down or memorizes it.

Stage 503: The first user removes the SIM card from the first mobile phone and installs a different SIM card with a different telephone number, TelNo2, in the first mobile phone.

Stage 504: APP1 receives “TelNo2” from the SIM card, either automatically or by user input, and submits the key-combination, Comb(TelNo2Key, APP1Key) automatically to the application server system.

Stage 505: Upon receipt of key-combination, Comb(TelNo2Key, APP1Key) the application server system automatically activates a second proprietary email account with the second email address “TelNo2@domainname.TLD”.

Stage 506: The application server system confirms to APP1 that a second proprietary email account has been activated.

Stage 507: Upon activation of second proprietary email account, either automatically or by user confirmation, the APP1 sends the contact list on the first mobile phone to the application server system to store it in or in association with the second proprietary email account.

Stage 508: The first user enters the number-change-code on APP1 to link the first proprietary email account to the second proprietary email account for accessing the first email account through the second email account address and submits it to the application server system.

Stage 509: Upon receipt of “number-change-code”, the application server system correspondingly links the first proprietary email account to the second proprietary email account, providing access to emails in the first proprietary email account through the second proprietary email account.

Stage 510: In the event, the first user does not remember the “number-change-code”, upon user command, APP1 sends a verification request to application server system to verify that the first proprietary email account belongs to the first user.

Stage 511: Upon receipt of the verification request, the application server systems compares the contact list stored for the first proprietary email account with the contact list on the first mobile phone. If the contact list on the first mobile phone matches a predetermined fraction, for example at least 80% or even 90%, of contacts stored for first proprietary account, the application server system links the first proprietary email account to the second proprietary email account, providing access to emails in the first proprietary email account through the second proprietary email account.

With reference to FIG. 6, the following stages are performed in order to change the APP from APP1 to APP2 and transferring the first proprietary email account to the new proprietary email account.

Stage 601: Upon user command and request, APP1 sends a request for an APPchange-code for the first proprietary email account to the application server system.

Stage 602: The application server system receives the request and sends an alphanumeral “APP-change-code” for first proprietary email account to APP1. The user notes this code down or memorizes it.

Stage 603: The first user removes the SIM card from the first mobile phone and installs the SIM card in a second mobile phone with APP2.

Stage 604: APP2 receives “TelNo1” from the SIM card, either automatically or by user input, and submits the key-combination, Comb(TelNo1Key, APP2Key) automatically to the application server system.

Stage 605: Upon receipt of key-combination, Comb(TelNo1Key, APP2Key) the application server system automatically activates a second proprietary email account with the email address “TelNo1@domainname.TLD”.

It must be noted that the email addresses “TelNo1@domainname.TLD” of the first and second proprietary email account are identical but the accounts different in the sense that the second account cannot be opened with the first key combination Comb(TelNo1Key, APP1Key) but only with the second key combination Comb(TelNo1Key, APP2Key) and vice versa. Only once, the APP-change-code has been entered, as explained in the following, or the contact list had been compared, the two accounts are linked. This is done to safeguard the interest of the users in case that the telephone number was acquired by a second user.

Stage 606: The application server system confirms to APP2 that a second proprietary email account has been activated.

Stage 607: Upon activation of second proprietary email account, either automatically or by user confirmation, APP2 sends the contact list on the second mobile phone to the application server system to store in the second proprietary email account.

Stage 608: The first user enters the “APP-change-code” on APP2 to link the first proprietary email account with the second proprietary email account and submits it to the application server system.

Stage 609: Upon receipt of “APP-change-code”, the application server system links the first proprietary email account to the second proprietary email account, providing access to emails in the first proprietary email account through the second proprietary email account.

Stage 610: In the event, the first user does not remember the “APP-change-code”, upon user command, APP1 sends a request to the application server system to verify that the first proprietary email account belongs to the first user.

Stage 611: Upon receipt of the request, the application server systems compares the contact list stored for the first proprietary email account and the contact list on the second mobile phone. If the contact list on the second mobile phone matches a predetermined fraction, for example at least 80 or even at least 90%, of contacts stored on first proprietary account, the application server system links the first proprietary email account to the second proprietary email account, providing access to emails in the first proprietary email account through the second proprietary email account.

Optionally, the first proprietary email account is also accessible from a laptop or desktop computer via a desktop application, which is associated with APP1 on the first mobile telephone and in function similar to APP1 on the first mobile telephone. For example, the desktop application mirrors APP1 and is synchronized with APP1. In such case, the application server system is linking APP1 and the desktop application upon submission of a desktop-access-code on the desktop application, which is sent by the application server system to APP1 upon user command and request.

If more than one proprietary email account is linked to APP1, in such a case all the proprietary email accounts linked to APP1 are also accessible from the desktop application.

In order to give further access possibilities, APP1 may also be accessible from any arbitrary Internet terminal via web applications, upon submission of the web-access-code on the web, which is sent by the application server system to APP1 upon user command and request.

When an email is received by the APP, the corresponding sender phone number is shown, or optionally the corresponding name from the contact list stored in the mobile telephone.

Further, as already indicated above, the proprietary email account can be linked to conventional email accounts such that emails received to “TelNo@domainame.TLD” are forwarded to the conventional email account. If the system uses a proprietary email format, the format is changed thereto, for example to SMTP format.

1. A system for activating an email account and sending and receiving emails on a mobile telephone, the system comprising
a first mobile telephone comprising a SIM card with a registered first telephone number, TelNo1, and with Internet access capabilities;
a first email software application, APP1, installed on the first mobile telephone, wherein APP1 is non-transferable to other mobile telephones after installation, wherein APP1 is configured for automatically providing a first software key and second software key, and sending a key-combination of the first and the second software key to an application server system associated with APP1;
an application server system associated with APP1 and configured for receiving the key-combination from APP1 as an authorization code for email transactions of a first email account, wherein the first email account is uniquely associated to the key-combination; wherein the application server system is configured for email transactions for receiving emails by the application server system from APP1 and sending the received email to a recipient address and receiving emails addressed to the first email account from other email addresses and sending those emails to APP1;
characterized in that
the first software key, TelNo1Key, is uniquely linked to the first telephone number and the second software key, APP1Key is uniquely linked to APP1; wherein the application server system is configured for email transactions for the first email account only upon receipt of the key-combination, Comb(TelNo1Key, APP1Key), as authorization code from the APP1, wherein the application server system is configured for automatic creation of the first email account as a consequence of a first-time receipt of the key-combination COMB(TelNo1Key, APP1Key) by the application server system, wherein an email address identifier of the first email account is an alphanumeric sequence containing TelNo1.

2. A system according to claim 1, wherein the application server system is configured for email transactions for the first email account only if the first SIM card has not been installed in another mobile telephone with a different email software application.

3. A system according to claim 1 or 2, wherein the application server system is configured for automatically creating a second email account as a consequence of either A or B, wherein
A) is receipt from APP1 a key-combination, Comb(TelNo2Key, APP1Key), wherein TelNo2Key is a software key uniquely associated with a different telephone number TelNo2 of a different SIM card in the first telephone; wherein the email address identifier of the second email account is an alphanumeric sequence containing TelNo2.
B) is receipt from a different email software application, APP2, a key-combination Comb(TelNo1Key, APP2Key), wherein APP2Key is a software key uniquely associated with APP2 on the first telephone or on a different telephone containing the first SIM card with the first telephone number TelNo1, wherein email address identifier of the second email account is identical of the email address identifier of the first email account containing TelNo1, and wherein the first email account discontinues working.

4. A system according to claim 3, wherein the application server system in event A) and B) is further configured for automatically
A) providing access by APP1 on the first telephone to previous emails from the first email account, if the received key-combination Comb(TelNo2Key, APP1Key), wherein TelNo2Key is a software key uniquely associated with a different telephone number TelNo2 of a different SIM card in the first telephone, is followed by receipt from APP1 of an authorised number-change-code that was previously sent from the application server system to APP1 upon request by a user command, or if there is at least 80% identity between the contact lists in the first telephone before and after change of telephone number from TelNo1 to TelNo2;
B) providing access by APP2 to previous emails from the first email account, if the received key-combination Comb(TelNo1Key, APP2Key) is followed by receipt from APP2 of an authorised APP-change-code that was previously sent from the application server system to APP1 upon request by a user command, or if there is at least 80% identity between the contact list in first telephone with APP1 and the contact list in the telephone with APP2.

5. A system according to any preceding claim, wherein the application server system is configured for email transactions for the first email account only if the first telephone comprises the SIM card with the registered first telephone number.

6. A method of operating a system with an email service on a mobile telephone, the method comprising
providing a first mobile telephone comprising a SIM card with a registered first telephone number, TelNo1, and with Internet access capabilities;
providing a first email software application, APP1, on the first mobile telephone, wherein APP1 is non-transferable to other mobile telephones after installation, by the APP1 automatically providing a first software key and second software key, and sending a key-combination of the first and the second software key to an application server system associated with APP1;
by the application server system receiving the key-combination from APP1 as an authorization code for email transactions of a first email account, wherein the first email account is uniquely associated to the key-combination; further by email transactions receiving emails by the application server system from APP1 and sending the received email to a recipient address and receiving emails addressed to the first email account from other email addresses and sending those emails to APP1,
characterized in that
the first software key, TelNo1Key, is uniquely linked to the first telephone number and the second software key, APP1Key is uniquely linked to APP1; wherein the application server system is configured for email transactions for the first email account only upon receipt of the key-combination, Comb(TelNo1Key, APP1Key), as authorization code from the APP1, and wherein the method comprises performing email transactions with APP1, wherein the method comprises first-time receiving the key-combination, Comb(TelNo1Key, APP1Key), by the application server system and, as a consequence thereof, automatically creating the first email account by the application server system wherein the method comprises providing the email address identifier of the first email account as an alphanumeric sequence containing TelNo1.

7. A method according to claim 6, wherein the method comprises removing the SIM card with TelNo1 from the first mobile telephone and installing a different SIM card with a different telephone number, TelNo2, in the first mobile telephone; by APP1 automatically providing a different first software key, TelNo2Key, and sending the resulting software key-combination, Comb(TelNo2Key, APP1Key), to the application server system, and as a consequence of receiving the software key-combination Comb(TelNo2Key, APP1Key), automatically creating a second email account by the application server system, wherein the second email account is uniquely associated to the key-combination Comb(TelNo2Key, APP1Key), wherein the email address identifier of the second email account is an alphanumeric sequence containing TelNo2.

8. A method according to claim 6 or 7, wherein the method comprises, by a user's input on a user interface of APP1 on the first mobile telephone by user command requesting a number-change-code from the application server system for change of telephone number from the first telephone number TelNo1 to a different telephone number; by APP1 receiving the number-change-code and displaying it to the user; then, removing the SIM card from the first mobile telephone and installing a different SIM card with a different telephone number, TelNo2, in the first mobile telephone; by APP1 automatically providing a different first software key, TelNo2Key, and sending the resulting software key-combination, Comb(TelNo2Key, APP1Key), to the application server system; inserting the number-change-code on a user interface of APP1 on the first mobile telephone and sending the number-change-code by APP1 to the application server system; as a consequence of receiving the number-change-code from APP1 by the application server system, providing access to emails in the first email account despite the change of software key-combination from Comb(TelNo1Key, APP1Key) to Comb(TelNo2Key, APP1Key).

9. A method according to claim 8, wherein the method comprises, as a consequence of the receipt of Comb(TelNo2Key, APP1Key), by the application server system automatically creating a second email account uniquely related to Comb(TelNo2Key, APP1Key); as a consequence of the receiving of the number-change-code from APP1 by the application server system, linking the first email account associated to TelNo1 to the second email account associated with TelNo2 and providing access to previous emails in the first email account through operation of the second email account.

10. A method according to anyone of the claims 6-9, wherein the method comprises, removing the SIM card from the first mobile telephone and installing the SIM card in a second mobile telephone; providing the second mobile telephone with a second email software application, APP2, similar to APP1 but with a different software key, APP2Key; by APP2 sending a software key-combination Comb(TelNo1Key, APP2Key) to the application server system, and as a consequence of the receipt of Comb(TelNo1Key, APP2Key), by the application server system automatically creating a further email account uniquely related to Comb(TelNo1Key, APP2Key), wherein email address identifier of the second email account is identical of the email address identifier of the first email account containing TelNo1, and wherein the first email account is discontinued working.

11. A method according to anyone of the claims 6-10, wherein the method comprises, by a user's input on a user interface of APP1 on the first mobile telephone by user command requesting an APP-change-code from the application server system for change of the APP; by APP1 receiving the APP-change-code and displaying it to the user; removing the SIM card from the first mobile telephone and installing the SIM card in a second mobile telephone; providing the second mobile telephone with a second email software application, APP2, similar to APP1 but with a different software key, APP2Key; by APP2 sending a software key-combination Comb(TelNo1Key, APP2Key) to the application server system; inserting the APP-change-code on a user interface of APP2 on the second mobile telephone and sending the APP-change-code by APP2 to the application server system; as a consequence of receiving APP-change-code from APP2 by the application server system, providing access to emails in the first email account despite the changed software key-combination from Comb(TelNo1Key, APP1Key) to Comb(TelNo1Key, APP2Key).

12. A method according to claim 11, wherein the method comprises, as a consequence of the receipt of the key-combination Comb(TelNo1Key, APP2Key) by the application server system, creating a second email account uniquely related to Comb(TelNo1Key, APP2Key); as a consequence of receiving of the APP-change-code from APP2 by the application server system, linking the first email account associated to APP1 to the second email account associated with APP2, and providing access to previous emails in the first email account through operation of the second email account.
